(19) United States
(12) Patent Application Publication
(10) Pub. No.: US 2004/0125869 A1
(43) Pub. Date: Jul. 1, 2004

(54) Method and apparatus for non-intrusive transceiver property adjustment

(76) Inventors: Michael R. May, Austin, TX (US); Michael D. Cave, Austin, TX (US); Mathew A. Rybicki, Austin, TX (US)

Correspondence Address: GARLICK HARRISON & MARKISON LLP, P.O. BOX 160727, AUSTIN, TX, 78716-0727, US

(21) Appl. No.: 10/376,581

(22) Filed: Feb. 28, 2003

Related U.S. Application Data
(60) Provisional application No. 60/437,362, filed on Dec. 31, 2002.

(51) Int. Cl. H04L 5/16; H04B 1/38

(52) U.S. Cl. 375/219

(57) ABSTRACT

A method and apparatus for non-intrusive transceiver property adjustment are disclosed. One embodiment of the method for non-intrusive transceiver property adjustment comprises: determining a transceiver property to be adjusted, detecting a distortion event in a signal, and adjusting the transceiver property. The transceiver property can be determined based on a user input and/or on a predefined schedule. The predefined schedule can comprise a set of property limits (e.g., power level, frequency, gain, etc.). The signal can be an orthogonal frequency domain multiplexing (“OFDM”) signal or any signal having a phase change at a symbol boundary. The distortion event can comprise such a phase change at a symbol boundary. The adjusted transceiver property can comprise any time-domain changing property. For example, the transceiver property can comprise one or more of: a postponed charge pump update, power amplifier power, phase-locked loop (“PLL”) frequency, filter cut-off frequencies, DC offsets, receiver gain, antenna diversity selection and RF transmission frequency. Further, the transceiver property can be adjusted in either the analog domain and/or the digital domain.

This patent application is claiming priority under 35 USC § 119(e) to provisional patent application having the same title as the present patent application, a serial number of 60/437,362, and a filing date of Dec. 31, 2002.

### TECHNICAL FIELD OF THE INVENTION

This invention relates generally to communication systems and, more particularly, to wireless communication systems. Even more particularly, the present invention relates to non-intrusive adjustment of radio frequency circuit characteristics and transmission channel characteristics.

### BACKGROUND OF THE INVENTION

As is known, wireless communication systems include a plurality of wireless communication devices and wireless infrastructure devices. The wireless communication devices, which may be radios, cellular telephones, stations coupled to personal computers, laptops, personal digital assistants, et cetera, communicate with each other via wireless communication channels that are administered by the wireless infrastructure devices. Such wireless infrastructure devices include base stations (e.g., for cellular wireless communication systems), access points (e.g., for wireless local area networks), system controllers, system administrators, et cetera. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device communicates directly or indirectly with other wireless communication devices. For direct communications (also known as point-to-point communications), the participating wireless communication devices tune their receivers and transmitters to the same channel or multiple channels (e.g., one or more of the plurality of radio frequency (RF) carriers of the wireless communication system) and communicate over that channel or channels. For indirect wireless communications, each wireless communication device communicates directly with an associated base station (e.g., for cellular services) and/or an associated access point (e.g., for an in-home or in-building wireless network) via an assigned channel, or channels. To complete a communication connection between the wireless communication devices, the associated base stations and/or associated access points communicate with each other directly, via a system controller, via the public switch telephone network, via the internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, a receiver receives RF signals, demodulates the RF carrier frequency from the RF signals to produce baseband signals, and demodulates the baseband signals in accordance with a particular wireless communication standard to recapture the transmitted data. A radio receiver is known to include a low noise amplifier, one or more intermediate frequency stages, filters and a receiver baseband processor. The low noise amplifier amplifies radio frequency (RF) signals received via an antenna and provides the amplified RF signals to the one or more intermediate frequency stages. The one or more intermediate frequency stages mixes the amplified RF signal with one or more local oscillations to produce a receive baseband signal. The receiver baseband processor, in accordance with a particular wireless communication standard, decodes and/or demodulates the baseband signals to recapture data therefrom. The radio receiver can be a multi-channel receiver capable of simultaneously receiving multiple RF signals.

As is also known, the transmitter converts data into RF signals by modulating the data to produce baseband signals and mixing the baseband signals with an RF carrier to produce RF signals. The radio transmitter includes a baseband processor, one or more intermediate frequency stages, filters, and a power amplifier coupled to an antenna. The baseband processor encodes and/or modulates, in accordance with a wireless communication standard such as IEEE 802.11a, IEEE802.11b, Bluetooth, Global System for Mobile communications (GSM), Advanced Mobile Phone Service (AMPS), et cetera, to produce baseband signals. The baseband processor produces an outbound baseband signal at a given processing rate. Typically, the processing rate of the transmitting baseband processor is synchronized with the transmitting local oscillation or oscillations and is a fraction of the local oscillation, or oscillations. The one or more intermediate frequency stages mix the baseband signals with one or more local oscillations to produce a radio frequency signal. The filter filters the radio frequency signal to remove unwanted frequency components and the power amplifier amplifies the filtered radio frequency signal prior to transmission via the antenna. The radio transmitter can be a multi-channel transmitter capable of simultaneously transmitting multiple RF signals.

However, multi-channel transmission systems suffer from signal degradation and data corruption when simultaneously transmitting on different channels originating from antennas within reception range of the receiver for which they are intended. This is because currently existing multi-channel systems do not provide for the synchronization of contemporaneously transmitted signals along two or more of their channels. As shown in FIG. 1, each burst of data 2 within a transmitted signal comprises multiple symbols 4 carrying a portion of the data making up the data burst. Each symbol comprises a data signal having a fixed amplitude and phase for the symbol, and a cyclic prefix (known as a guard interval in IEEE 802.11a). The cyclic prefix is essentially a portion of the symbol data repeated prior to the transmission of the data. The end portion of a symbol is copied and repeated within the cyclic prefix for the corresponding symbol. The cyclic prefix is used to allow the noise injected due to the discontinuity from symbol to symbol to settle before the data is actually sampled and is essentially a throwaway portion of the symbol data. As shown in FIG. 1, between the data of one symbol and the cyclic prefix of another symbol, a discontinuity results since the transmitted analog baseband signal is changing from one encoded data set to another.

Unsynchronized signals transmitted contemporaneously from antennas in range of the receiver will thus interfere with one another if the guard intervals of the symbols of one signal are not aligned with the guard intervals of the symbols of the other signal. The interference occurs because the non-aligned noise injected due to the discontinuity from symbol to symbol of one signal will disturb the data portion of the symbols on the other signal, and vice versa. This is illustrated in FIG. 2, which shows an analogous case to that of FIG. 1 for contemporaneously transmitted signals 5 and 6. U.S. patent application Ser. No. ______, entitled “METHOD AND APPARATUS FOR SYNCHRONIZED CHANNEL TRANSMISSION”, attorney docket No. VIXS 056, discloses a method and system for synchronized channel transmission that effectively eliminates the problems discussed above for unsynchronized simultaneous transmissions.

However, because the cyclic prefix (guard interval) is a throwaway portion of the symbol data, it is also a wasted time period. The cyclic prefix time interval could be used to make changes within the transceiver in a non-intrusive manner, given the throwaway nature of the signal during this interval. Prior art transmission systems do not take advantage of the cyclic prefix to change transmission signal characteristics or to make other non-intrusive changes in the processing and transmission of a data signal.

Therefore, a need exists for a method and apparatus for non-intrusive adjustment to a transceiver and an associated signal that can reduce or eliminate the problems associated with the prior art.

### BRIEF SUMMARY OF THE INVENTION

The embodiments of the method and apparatus for non-intrusive transceiver property adjustment of this invention substantially meet these needs and others. One embodiment of the method for non-intrusive transceiver property adjustment comprises: determining a transceiver property to be adjusted, detecting a distortion event in a signal, and adjusting the transceiver property. The transceiver property can be determined based on a user input and/or on a predefined schedule. The predefined schedule can comprise a set of property limits (e.g., power level, frequency, gain, etc.). The signal can be an orthogonal frequency domain multiplexing (“OFDM”) signal or any signal having a phase change at a symbol boundary. The distortion event can comprise such a phase change at a symbol boundary.

The transceiver property that is adjusted can comprise any time-domain changing property. For example, the transceiver property can comprise one or more of: a postponed charge pump update, power amplifier power, phase-locked loop (“PLL”) frequency, filter cut-off frequencies, DC offsets, receiver gain, antenna diversity selection and RF transmission frequency. Further, the transceiver property can be adjusted in either the analog domain and/or the digital domain.

The embodiments of the method and apparatus for non-intrusive transceiver property adjustment of the present invention thus allow for the performing of essentially any time-domain change (e.g., a transceiver property adjustment) during a distortion event, such as a guard interval period. The embodiments of the present invention can perform such changes in a manner as known to those familiar with the art. The various embodiments of the method and apparatus of this invention can be incorporated in a radio or other wireless communication device and can comprise a multi-channel transmitter within such a radio or other device.

The embodiments of the present invention can thus take advantage of an otherwise wasted distortion event interval of a data signal's symbol data to effectuate changes in the transmitted/received data signal and/or the transceiver system. The advantage of making changes during a distortion event is that the distortion event is a throwaway portion of the signal data symbols. Therefore, adjustments made during this period will not typically cause a detrimental effect to the signal. Further, if the distortion events, such as the guard interval periods of simultaneously transmitted signals, are synchronized, as discussed below, multi-channel transmission systems can effectively change characteristics of one or both (or all) transmission channels without adversely affecting any other contemporaneously transmitted signal on another channel.

### BRIEF DESCRIPTION OF THE SEVERAL VIEWS OF THE DRAWINGS

FIG. 1 is a time domain representation of bursts of data and corresponding noise in accordance with the present invention;

FIG. 2 is a time domain representation of bursts of data for two channels and corresponding noise in accordance with the present invention;

FIG. 3 is a logic diagram illustrating an embodiment of the method for non-intrusive transceiver property adjustment in accordance with this invention;

FIG. 4 is a schematic block diagram illustrating one embodiment of a radio transceiver in accordance with this invention; and

FIG. 5 is a schematic block diagram illustrating an apparatus for non-intrusive transceiver property adjustment in accordance with this invention.

### DETAILED DESCRIPTION OF THE INVENTION

The embodiments of the present invention provide a method and apparatus capable of using an otherwise wasted distortion event interval of a data signal's symbol data to effectuate changes in a transmitted/received data signal and/or in a transceiver system. This capability provides an advantage over the prior art because the distortion event interval is a throwaway portion of the signal data symbols. Therefore, adjustments made during this period will not typically cause a detrimental effect to the signal. Further, if the distortion events, such as the guard interval periods of simultaneously transmitted signals are synchronized, multi-channel transmission systems can effectively change characteristics of one or both (or all) transmission channels without adversely affecting any other contemporaneously transmitted signal on another channel.

The embodiments of the present invention can provide for making such changes in either the digital or analog domain or both. Adjustments can thus be made to characteristics of either the transmit or the receive paths of a transceiver system implementing an embodiment of the present invention. For example, the performance of a phase-locked loop (“PLL”) circuit can be improved by postponing a charge pump update until a distortion event (e.g., a guard interval) period. Similarly, other transceiver properties that periodically, or randomly, require adjusting can have the level of adjustment determined at any time with respect to RF transmissions, but the actual adjustment would be done during a distortion event. These and other changes/adjustments can be made in a manner known to those familiar with the art.

The embodiments of the present invention can be used to perform essentially any time-domain change (e.g., a transceiver property change) during a distortion event, such as a cyclic prefix (guard interval) period. As long as the adjustment/change can be accomplished during the distortion event time interval, any such change as known to those familiar with the art can be performed. For example, transceiver properties that can be adjusted include: adjusting power amplifier power (which is normally done on a data packet boundary), so as to better handle a signal peak or to improve link performance; adjusting PLL frequency (i.e., the VCO frequency); performing charge pump updates; changing filter cut-off frequencies (e.g., digital and/or analog filter coefficients, saw filter switching); performing DC offsets updates; adjusting receiver gain; performing antenna diversity switching; and/or performing frequency hopping.

One or more properties can be adjusted during the same distortion event. A guard interval/cyclic prefix is but one example of a distortion event. The present invention contemplates a distortion event to be any event that either adversely affects a signal transmission/reception, thus allowing for the performance of a change such as discussed above without further adverse affects, or that does not adversely affect the signal transmission/reception, but that would otherwise be wasted signal (e.g., a guard interval period). Thus, for example, any system using a signal with a phase, amplitude, or frequency change at a symbol boundary can be used to implement an embodiment of this invention (i.e., the changes discussed above can be effectuated during the phase change).

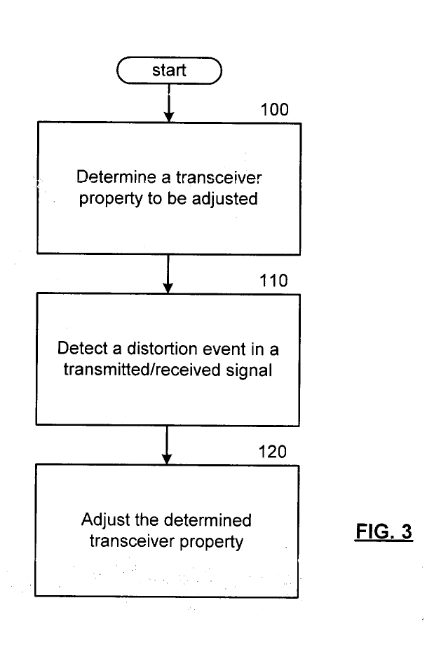

The present invention can be more fully described with reference to FIGS. 3 through 5. FIG. 3 is a logic diagram illustrating the steps of an embodiment of the method for non-intrusive transceiver property adjustment of this invention. The method may be performed by any radio, single channel transceiver, or multi-channel transceiver illustrated and described herein. At step 100, the method involves determining a transceiver property to be adjusted. The property can be any time domain changing property as described above. The transceiver property can be determined according to a pre-defined schedule and/or based on a user input. For example, a system administrator may decide to change or adjust a property and input means for implementing such a change are within the scope of this invention (e.g., a keyboard or other manual entry interface). Further, a pre-defined schedule can comprise any set schedule, such as according to effectuating a change if a property limit is exceeded (e.g., a minimum or maximum power level), an arbitrary user-set schedule, a round-robin schedule, a schedule based on occurrence of a casualty to equipment or signal quality, etc.

At step 110, a distortion event is determined in a transmitted or received signal based on known properties of the radio operation and/or based on predictions of a distortion event. The signal can be any signal having a phase, amplitude, or frequency change at a symbol boundary, for example, an orthogonal frequency domain multiplexing modulated signal. The distortion event can be any event as described above. The existence and time of occurrence of a distortion event can be determined in any manner known to those familiar with the art or determined based on the known operating parameters of the radio architecture. For example, if an OFDM symbol with a large peak value is being prepared as the next symbol for transmission, then it may be advantageous to increase the power amplifier (PA) bias current to increase the drive strength of the PA during transmission of the symbol. At step 120, the determined transceiver property is adjusted according to the pre-defined schedule or based on a user input during the distortion event. The transceiver property can be adjusted in the analog domain, the digital domain, or both.

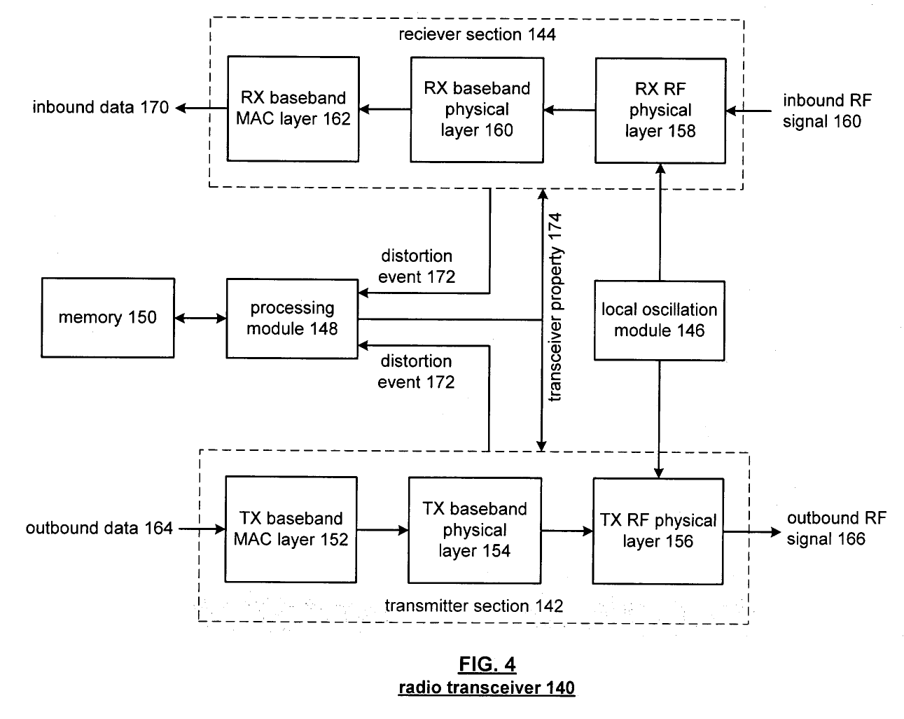

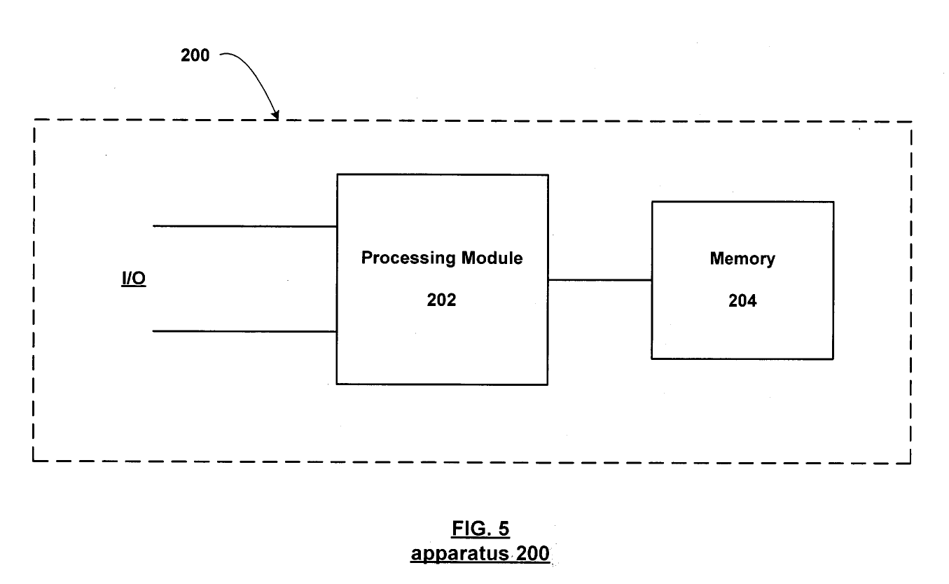

FIG. 4 is a schematic block diagram of a radio transceiver 140 that includes a transmitter section 142, a receiver section 144, a local oscillation module 146, a processing module 148, and memory 150. The processing module 148 and memory 150 may be of a similar construct as processing module 202 and memory 204 of FIG. 5. The transmitter section 142 includes a transmit (TX) baseband Media-specific Access Control protocol (MAC) layer 152, TX baseband physical layer 154, and a TX radio frequency (RF) physical layer 156. The receiver section 144 includes a receive (RX) RF physical layer 158, a RX baseband physical layer 160, and a RX baseband MAC layer 162.

In operation, the receiver section 144 receives inbound RF signals 160 via the RX RF physical layer 158. The RX RF physical layer 158 may include a low noise amplifier, at least one intermediate frequency stage, and may also include an RF bandpass filter. The low noise amplifier amplifies the inbound RF signal, which may then be filtered by the RF bandpass filter. The intermediate frequency (IF) stage directly, or in multiple stages, converts the filtered and amplified inbound RF signal into a baseband signal in accordance with the local oscillation, or oscillations, provided by the local oscillation module 146. The RX baseband physical layer 160 may include a low pass filter, gain or attenuation stage, and an analog to digital converter to produce a digital representation of the baseband signal (e.g., symbols for OFDM) provided by the RX RF physical layer 158. The RX baseband MAC layer 162 processes the digital representation of the baseband signal to produce inbound data 170, which may be voice data, text data, audio data, and/or video data. The processing includes, but is not limited to, digital intermediate frequency to baseband conversion, demodulation, constellation demapping, decoding, and/or descrambling.

The transmitter section 142 receives outbound data 164, which may be voice data, text data, audio data, and/or video data, via the TX baseband MAC layer 152. The TX baseband MAC layer processing the outbound data 164 in accordance with a modulation scheme and/or encoding scheme proscribed by the communication standard to which the radio is compliant to produce processed signals (e.g., symbols for OFDM). The processing includes, but is not limited to, scrambling, encoding, constellation mapping, modulation, and/or digital baseband to IF conversion. The TX baseband physical layer 154 converts the processed signals into analog signals and may low pass filter the analog signals. The TX RF physical layer 156 converts the filtered analog signals into outbound RF signals 166 via one or more intermediate frequency stages and a power amplifier (PA). The intermediate frequency stage(s) mixes the filtered analog signals with one or more local oscillations provided by the local oscillation module 146 to produce up-converted signals. The power amplifier amplifies the up-converted signals to produce the outbound RF signals 166.

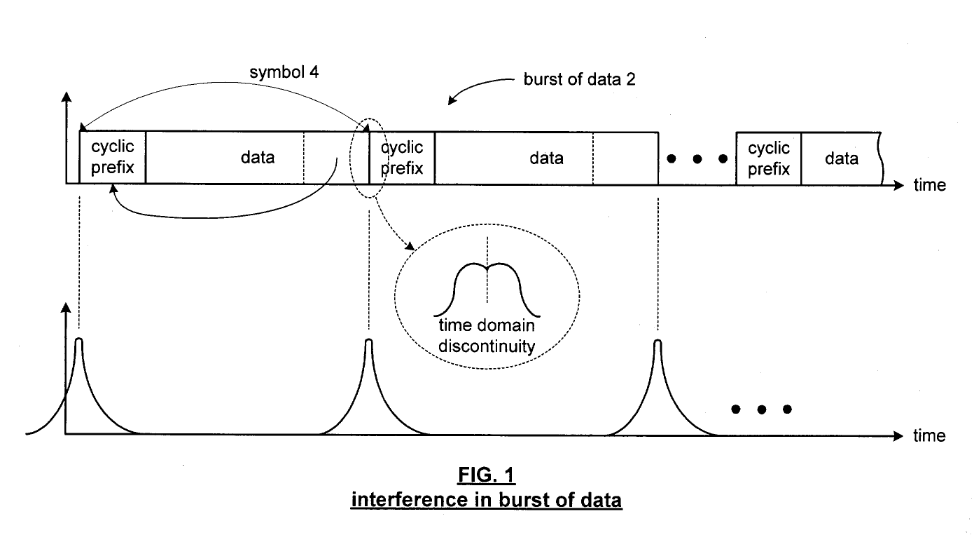

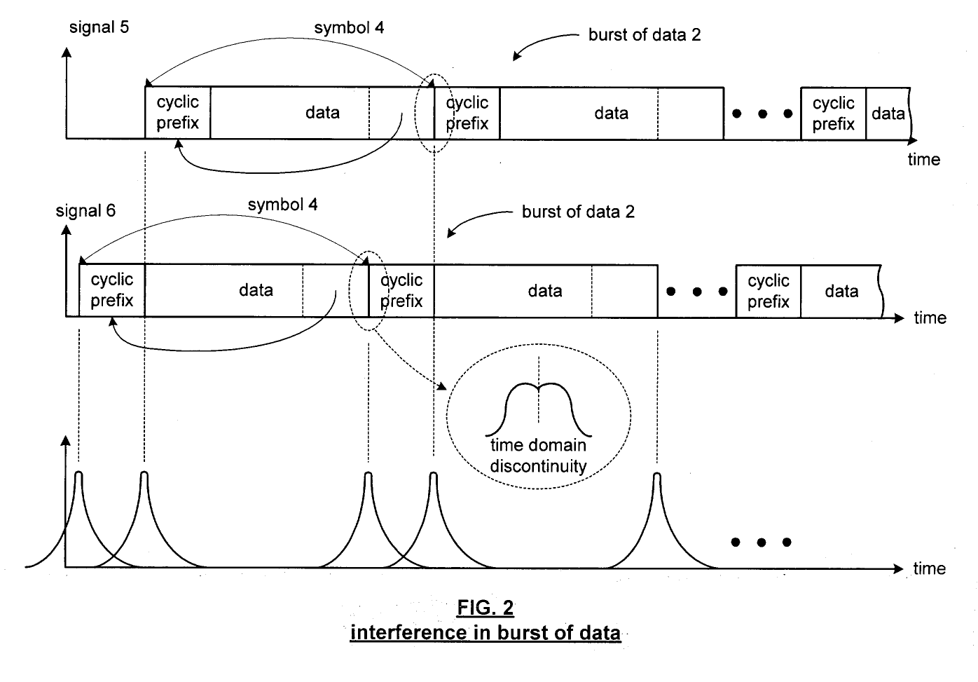

In further operation of the radio transceiver 140, transceiver properties 174 of the transmitter section 142 and/or of the receiver section 144 may need to be adjusted. Such transceiver properties include, but are not limited to, adjusting power amplifier power (which is normally done on a data packet boundary), so as to better handle a signal peak or to improve link performance; adjusting PLL frequency (i.e., the VCO frequency); performing charge pump updates; changing filter cut-off frequencies (e.g., digital and/or analog filter coefficients, saw filter switching); performing DC offsets updates; adjusting receiver gain; performing antenna diversity switching; and/or performing frequency hopping. The processing module 148, while executing the operational instructions stored in memory 150, which have been described with reference to FIGS. 1-3, determines when a transceiver property is to be adjusted. In addition, the processing module 148 determines when a distortion event 172 occurs within the receiver section 144 and/or within the transmitter section 142. Accordingly, the processing module 148 controls the adjustment of the transceiver property to be done during the distortion event.

In an RF implementation of radio transceiver 140, the particular RF frequencies used are dictated by governmental agencies, such as the Federal Communications Commission (FCC). Typically, such in-home frequencies range from the hundreds of megahertz to gigahertz frequency ranges. One particular type of RF in-home application of interest is dictated by ITC specification 802.11a. The 802.11a specification provides the operating parameters for using radio frequencies for transceiving data within homes and/or over short distances (e.g., less than 300 meters).

A further embodiment of the present invention can comprise an apparatus for non-intrusive transceiver property adjustment. As shown in FIG. 5, the apparatus 200 can comprise a processing module 202 and a memory 204. Processing module 202 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 204 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 202 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory 204 stores, and the processing module 202 executes, operational instructions corresponding to at least some of the steps and/or functions illustrated in FIGS. 3 and 4.

In a particular embodiment of apparatus 200, the memory 204 is operably coupled to processing module 202 and includes operational instructions that cause the processing module 202 to determine a transceiver property to be adjusted, detect a distortion event in a signal, and adjust the transceiver property during the distortion event. The memory 204 of apparatus 200 can further comprise operational instructions that cause the processing module 202 to perform all of the steps of the method for non-intrusive transceiver property adjustment of this invention described above with respect to FIGS. 3 and 4.

The present invention provides a method and apparatus for non-intrusive transceiver property adjustment that overcome the problems of prior art transceiver property adjustment systems and methods. Further embodiments of the present invention can comprise a radio transceiver implementing an embodiment of the method of this invention. As one of average skill in the art will appreciate, other embodiments may be derived from the teaching of the present invention, without deviating from the scope of the claims.

What is claimed is:

1. A method for non-intrusive transceiver property adjustment, comprising:
determining a transceiver property to be adjusted;
determining a distortion event in a signal; and
adjusting the transceiver property during the distortion event.

2. The method of claim 1, wherein the transceiver property is determined based on a user input.

3. The method of claim 1, wherein the transceiver property is determined based on a predefined schedule.

4. The method of claim 3, wherein the predefined schedule comprises a set of property limits.

5. The method of claim 1, wherein the signal comprises an orthogonal frequency domain multiplexing (“OFDM”) signal.

6. The method of claim 1, wherein the signal comprises a signal having a phase, amplitude, or frequency change at a symbol boundary.

7. The method of claim 6, wherein the distortion event comprises the phase, amplitude, or frequency change.

8. The method of claim 1; wherein the distortion event comprises a phase, amplitude, or frequency change at a symbol boundary or a guard interval.

9. The method of claim 1, wherein the transceiver property comprises an adjustment in at least one of: the analog domain and the digital domain.

10. The method of claim 1, wherein the transceiver property comprises at least one of: a postponed charge pump update, power amplifier power, phase-locked loop (“PLL”) frequency, filter cut-off frequencies, DC offsets, receiver gain, antenna diversity selection and RF transmission frequency.

11. The method of claim 1, wherein the transceiver property comprises any time-domain changing property.

12. An apparatus for non-intrusive transceiver property adjustment, the apparatus comprising:
a processing module; and
a memory operably coupled to the processing module, wherein the memory includes operational instructions that cause the processing module to:
determine a transceiver property to be adjusted;
determine a distortion event in a signal; and
adjust the transceiver property during the distortion event.

13. The apparatus of claim 12, wherein the memory further comprises operational instructions that cause the processing module to determine the transceiver property based on a user input.

14. The apparatus of claim 12, wherein the memory further comprises operational instructions that cause the processing module to determine the transceiver property based on a predefined schedule.

15. The apparatus of claim 14, wherein the predefined schedule comprises a set of property limits.

16. The apparatus of claim 12, wherein the signal comprises an orthogonal frequency domain multiplexing (“OFDM”) signal.

17. The apparatus of claim 12, wherein the signal comprises a signal having a phase, amplitude, or frequency change at a symbol boundary.

18. The apparatus claim 17, wherein the distortion event comprises the phase, amplitude, or frequency change.

19. The apparatus of claim 12, wherein the distortion event comprises a phase, amplitude, or frequency change at a symbol boundary.

20. The apparatus of claim 12, wherein the memory further comprises operational instructions that cause the processing module to adjust the transceiver property in at least one of: the analog domain and the digital domain.

21. The apparatus of claim 12, wherein the transceiver property comprises at least one of: a postponed charge pump update, power amplifier power, phase-locked loop (“PLL”) frequency, filter cut-off frequencies, DC offsets, receiver gain, antenna diversity selection and RF transmission frequency.

22. The apparatus of claim 12, wherein the transceiver property comprises any time-domain changing property.

23. A radio transceiver comprising:
a receiver section operably coupled to convert inbound radio frequency (“RF”) signals into inbound data based on a receiver local oscillation;
a transmitter section operably coupled to convert outbound data into outbound RF signals based on a transmitter local oscillation;
a processing module;
a memory operably coupled to the processing module, wherein the memory includes operational instructions that cause the processing module to:
determine a transceiver property to be adjusted;
determine a distortion event in a signal; and
adjust the transceiver property during the distortion event; and
a local oscillator operably coupled to produce the transmitter local oscillation and the receiver local oscillation.

24. The radio transceiver of claim 23, wherein the memory further comprises operational instructions that cause the processing module to determine the transceiver property based on a user input.

25. The radio transceiver of claim 23, wherein the memory further comprises operational instructions that cause the processing module to determine the transceiver property based on a predefined schedule.

26. The radio transceiver of claim 25, wherein the predefined schedule comprises a set of property limits.

27. The radio transceiver of claim 23, wherein the signal comprises an orthogonal frequency domain multiplexing (“OFDM”) signal.

28. The radio transceiver of claim 23, wherein the signal comprises a signal having a phase, amplitude, or frequency change at a symbol boundary.

29. The radio transceiver of claim 28, wherein the distortion event comprises the phase, amplitude, or frequency change.

30. The radio transceiver of claim 23, wherein the distortion event comprises a phase, amplitude, or frequency change at a symbol boundary.

31. The radio transceiver of claim 23, wherein the memory further comprises operational instructions that cause the processing module to adjust the transceiver property in one of: the analog domain and the digital domain.

32. The radio transceiver of claim 23, wherein the transceiver property comprises at least one of: a postponed charge pump update, power amplifier power, phase-locked loop (“PLL”) frequency, filter cut-off frequencies, DC offsets, receiver gain, antenna diversity selection and RF transmission frequency.

33. The radio transceiver of claim 23, wherein the transceiver property comprises any time-domain changing property.

34. The radio transceiver of claim 23, wherein the radio transceiver comprises a multi-channel radio transceiver.
